(19) United States
(12) Patent Application Publication
(10) Pub. No.: US 2010/0250561 A1
(43) Pub. Date: Sep. 30, 2010

(54) CONTENTS DISPLAY SYSTEM, CONTENTS DISPLAY METHOD AND CONTENTS DISPLAY PROGRAM

(75) Inventors: Kyosuke Nishiyama, Tokyo (JP); Shuji Senda, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/739,781

(22) PCT Filed: Oct. 31, 2008
(86) PCT No.: PCT/JP2008/069882

§ 371 Date: Jun. 8, 2010

(30) Foreign Application Priority Data
Nov. 1, 2007 (JP) 2007-285207

(51) Int. Cl. G06F 17/30

(52) U.S. Cl. 707/754; 707/E17.059

(57) ABSTRACT

The present invention is directed to a contents display system that arranges an image corresponding to contents in accordance with predetermined attribute information. The contents display system is provided with a contents arrangement means that arranges a contents image corresponding to contents that do not meet a predetermined limitation condition at a position where a viewing recognition of at least part of the contents corresponding image is not obstructed by a contents image corresponding to contents that meet a predetermined limitation condition.

### APPLICABLE FIELD IN THE INDUSTRY

The present invention relates to a contents display system having a function of filtering contents being displayed, a contents display method; and a contents display program, and more particularly, to a contents display system for displaying not-filtered contents as well, a contents display method, and a contents display program.

### BACKGROUND ART

In general, as a method of displaying a distribution or a relevancy of a large volume of the contents such as retrieved data, the technique of expressing the contents with symbols, for example, an icon and a thumbnail, and arranging the above symbols over a characteristic space based upon a certain feature of the contents is often employed.

For example, Patent document 1 discloses a viewer of arranging thumbnail images representative of pictures taken with a digital camera on a time axis of one row with a photographing time defined as a feature.

Further, Patent document 2 discloses that a car navigation apparatus arranges and displays icons such as traffic regulation information on a map.

The display techniques disclosed in the Patent document 1 and the patent document 2 are characterized in that a difference of the feature (for example, a photographing time and a position) between the contents is expressed as a distance of the symbol that is displayed as it stands, and thus, a feature distribution or tendency of the contents can be easily grasped.

On the other hand, such display techniques arouse a problematic point that when a large volume of the contents resembling each other in the feature exist, the symbols thereof overlap each other, and visual recognizability of the individual contents become worse for a user because the position of the symbol is governed by the feature.

As a method of coping with this problem, the technique of limiting the contents being displayed in such a manner that the contents do not overlap each other is employed.

For example, the Patent document 2 discloses the scheme of preventing the parking area display marks from becoming hardly visible due to overlap thereof by affixing a priority degree to a parking area display mark, and making a non-display mark of the parking area display mark having a low priority degree, out of the parking area display marks overlapping each other.

In addition, as another means, a filtering operation of setting a condition associated with a text of the contents and additional information, and displaying only the contents that have met the above condition is generally performed.

It is described in Patent document 3 that a user sets a range of a date and a season, and an image display device, which maps the picture image to a photographing position in a map, and displays it, has a function of displaying only the pictures that meet the above condition, and not displaying the pictures that do not meet it.

Further, in Patent document 4, as a map display device that takes a guidance condition regarding a route into consideration and realizes a map display more appropriately displayed, the map display device for displaying an information display/menu window screen (sub screen) in a region other than the region screen in which the above guidance route is displayed is disclosed.

Patent document 1: JP-P2004-328265A

Patent document 2: Japanese Patent No. 3696073

Patent document 3: JP-P2007-156849A

Patent document 4: JP-P2006-300955A

### DISCLOSURE OF THE INVENTION

### Problems to be Solved by the Invention

The display technique having a filtering function described in the Patent documents 1 to 3, as a rule, does not display at all the data that has not meet the filtering condition. This arouses the following problematic points.

A first problematic point is that information of a density or a distribution of the contents is lost. The reason is that the density of the contents being displayed is decreased remarkably in some cases because the data that has not met the filtering condition is made non-display data of.

A second problematic point is that the user has difficult in adjusting a filtering threshold. The reason is that it is difficult to predict how the situation behaves when the filtering condition is relaxed because all of the data that has not met the filtering condition has been made non-display data of.

Further, the Patent document 4 discloses that when both of the guidance route and the sub screen have to be displayed, changing the display position of the sub screen having a low priority degree allows the sub screen to be displayed without generating fog in the display of the guidance path having a high priority degree. The sub screen is a screen for indicating a function menu etc., and the display position itself has no meaning, so no problem is raised even though the display position is moved. That is, it is described in the Patent document 4 that the display position of the information (sub screen), which needs to be displayed, and yet, of which the display position itself has no meaning, is moved. However, the Patent document 4 does not take the information of which the display position itself has meaning into consideration.

Thereupon, the present invention has an object of providing a contents display system in which information of a density or a distribution of the contents is not lost even though the contents meaningful in the position in which the contents are displayed are filtered, and the user easily can adjust the filtering conditions, a contents display method, and a contents display program.

### Means to Solve the Problem

The present invention for solving the above-mentioned problems, which is a contents display system of arranging contents-corresponding images corresponding to the contents based upon predetermined attribute information, is characterized in including a contents arrangement means for arranging the contents-corresponding images corresponding to the contents that have not met a predetermined filtering condition at a position in which a visual recognition of at least one part of these contents-corresponding images is not obstructed by the contents-corresponding images corresponding to the contents that have met the foregoing predetermined filtering condition.

The present invention for solving the above-mentioned problems, which is a contents display method of arranging contents-corresponding images corresponding to the contents based upon predetermined attribute information, is characterized in including a contents arrangement step of arranging the contents-corresponding images corresponding to the contents that have not met a predetermined filtering condition at a position in which a visual recognition of at least one part of these contents-corresponding images is not obstructed by the contents-corresponding images corresponding to the contents that have met the foregoing predetermined filtering condition.

The present invention for solving the above-mentioned problems, which is a contents display program for arranging contents-corresponding images corresponding to the contents based upon predetermined attribute information, is characterized in causing an information processing device to execute a contents arrangement process of arranging the contents-corresponding images corresponding to the contents that have not met a predetermined filtering condition at a position in which a visual recognition of at least one part of these contents-corresponding images is not obstructed by the contents-corresponding images corresponding to the contents that have met the foregoing predetermined filtering condition.

### AN ADVANTAGEOUS EFFECT OF THE INVENTION

The present invention has an advantageous effect that information of a density or a distribution of the contents is not lost even though the contents being displayed are filtered, and the filtering condition can be easily adjusted.

### BRIEF DESCRIPTION OF THE DRAWINGS

FIG. 1 is a block diagram illustrating a minimum exemplary configuration of the contents display system in accordance with the present invention.

FIG. 2 is a block diagram illustrating a first embodiment of the contents display system in accordance with the present invention.

FIG. 3 is a flowchart illustrating an operation of the contents display system in the first embodiment.

FIG. 4 is a block diagram illustrating a second embodiment of the contents display system in accordance with the present invention.

FIG. 5 is a flowchart illustrating an operation of the contents display system in the second embodiment.

FIG. 6 is an explanatory view for illustrating an exemplary output in the case of having retrieved restaurants by employing a general-purpose map retrieval system.

FIG. 7 is an explanatory view for illustrating an exemplary output in the case of having further filtered the retrieved restraints under the filtering condition in a general-purpose map retrieval system.

FIG. 8 is an explanatory view for illustrating an exemplary output in the case of changing and displaying colors of the icons of the restaurants that have not met.

FIG. 9 is an explanatory view for illustrating an example of a basic thumbnail arrangement of a thumbnail picture viewer of the second embodiment.

FIG. 10 is an explanatory view for illustrating an exemplary output in the case of arranging only passing data.

FIG. 11 is an explanatory view for illustrating an exemplary output in a situation in which an arrangement of excluded data has been completed.

### DESCRIPTION OF NUMERALS

10 contents arrangement means
11 first contents arrangement means
12 second contents arrangement means
100 contents display system

### BEST MODE FOR CARRYING OUT THE INVENTION

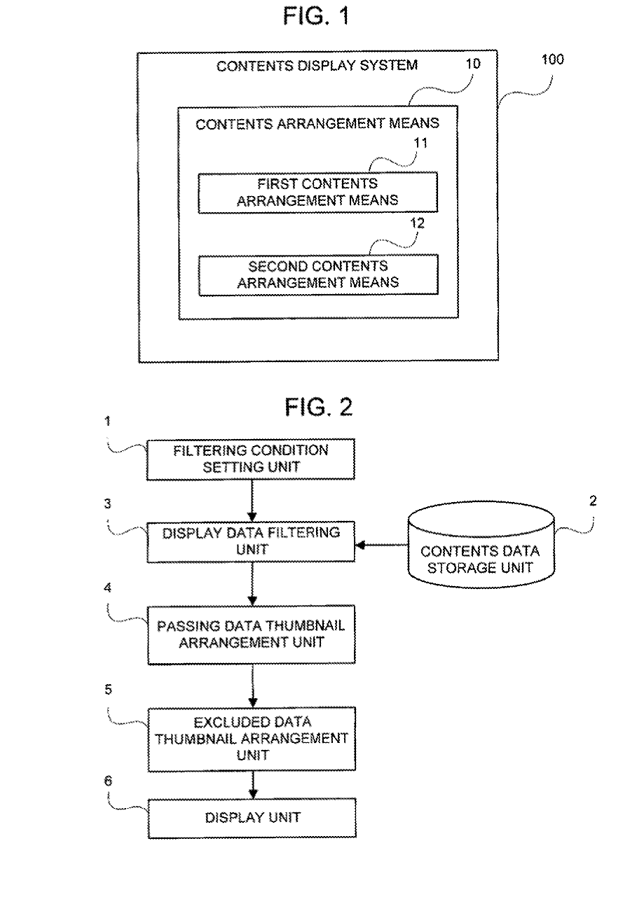

At first, an outline of the present invention will be explained by making a reference to the accompanied drawings. FIG. 1 is a block diagram illustrating a minimum exemplary configuration of the contents display system in accordance with the present invention. A contents display system 100 exemplified in FIG. 1 includes a contents arrangement means 10.

The contents display system 100 is a system for arranging the contents-corresponding images corresponding to the contents based upon the predetermined attribute information.

The contents arrangement means 10 includes a first contents arrangement means 11 and a second contents arrangement means 12.

The first contents arrangement means 11 arranges the contents-corresponding images corresponding to the contents that have met the predetermined filtering condition.

The second contents arrangement means 12 arranges the contents-corresponding images corresponding to the contents that have not met the filtering condition at a position in which a visual recognition of at least one part of the above contents-corresponding images is not obstructed by the contents-corresponding images corresponding to the contents arranged by the foregoing first contents arrangement means.

Making a configuration as shown in FIG. 1 yields an effect that a distribution or a density of the contents can be easily grasped, and the filtering conditions can be easily adjusted because the contents that have not met the filtering condition can be displayed in a space in which the contents that have met the filtering condition have not been displayed.

### First Embodiment

Next, the first embodiment of the present invention will be explained by making a reference to the accompanied drawings. FIG. 2 is a block diagram illustrating the first embodiment of the contents display system in accordance with the present invention. Upon making a reference to FIG. 2, the first embodiment of the present invention includes a filtering condition setting unit 1, a contents data storage unit 2, a display data filtering unit 3, a passing data thumbnail arrangement unit 4, an excluded data thumbnail arrangement unit 5, and a display unit 6.

The filtering condition setting unit 1 sets the condition (hereinafter, referred to as a filtering condition) for displaying one part, out of the contents data. The filtering condition is, for example, a retrieval condition that the user inputs in order to extract the desired contents from the contents data storage unit 2.

The contents data storage unit 2 stores the contents data.

The display data filtering unit 3 filters the contents data inputted from the contents data storage unit 2 on the basis of the condition set by the filtering condition setting unit 1. The display data filtering unit 3 separates the contents data into data (hereinafter referred to as passing data) that has met the filtering condition and should be displayed, and data (hereinafter referred to as excluded data) that has not met the filtering condition. That is, the display data filtering unit 3 searches the contents data storage unit 2 based upon the filtering condition, and extracts the passing data and the excluded data, respectively.

The passing data thumbnail arrangement unit 4 receives the passing data inputted from the display data filtering unit 3. Further, the passing data thumbnail arrangement unit 4 arranges the thumbnail image (passing data thumbnail), being a contents-corresponding image corresponding to each passing data, based upon a predetermined arrangement condition. That is, the passing data thumbnail arrangement unit 4 decides the position in which the thumbnail image (passing data thumbnail) corresponding to each passing data is arranged based upon a feature (attribution information) affixed to the passing data, and arranges the above thumbnail image.

Further, the excluded data thumbnail arrangement unit 5 arranges the thumbnail image (excluded data thumbnail), being a contents-corresponding image corresponding to each excluded data, based upon a predetermined arrangement condition. That is, the excluded data thumbnail arrangement unit 5 decides a position in which the thumbnail image (excluded data thumbnail) corresponding to each excluded data is arranged based upon a feature affixed to the excluded data. The excluded data thumbnail arrangement unit 5 arranges the thumbnail image of each excluded data in such a manner that the already-arranged passing data thumbnails are not obscured only when the decided position has not been occupied by the already-arranged passing data thumbnail, and thus, a space exists. That is, the excluded data thumbnail arrangement unit 5 arranges the excluded data thumbnail at a position in which a visual recognition of at least one part of the excluded data thumbnails is not obstructed by the already-arranged passing data thumbnails or excluded data thumbnails.

The so-called feature, which is, for example, positional information of latitude, longitude, etc., information indicative of an image quality of the image, and information indicative of the photographing time, corresponds to information indicative of coordinate axes of a coordinate space on a screen region. Further, the so-called arrangement of the contents such as the passing data and the excluded data signifies an arrangement of the contents-corresponding images corresponding to the contents on the screen.

For example, when a display range of the excluded data thumbnail does not overlap that of the passing data thumbnail completely, namely, the former overlaps the latter partially, the excluded data thumbnail arrangement unit 5 arranges only the part in which the display range of the excluded data thumbnail does not overlap that of the passing data thumbnail (the part corresponding to the space other than the display range of the passing data thumbnail), out of the display range of the excluded data thumbnail, on the screen.

The display unit 6 takes a control for displaying the arranged thumbnail on an output device (not shown in the figure).

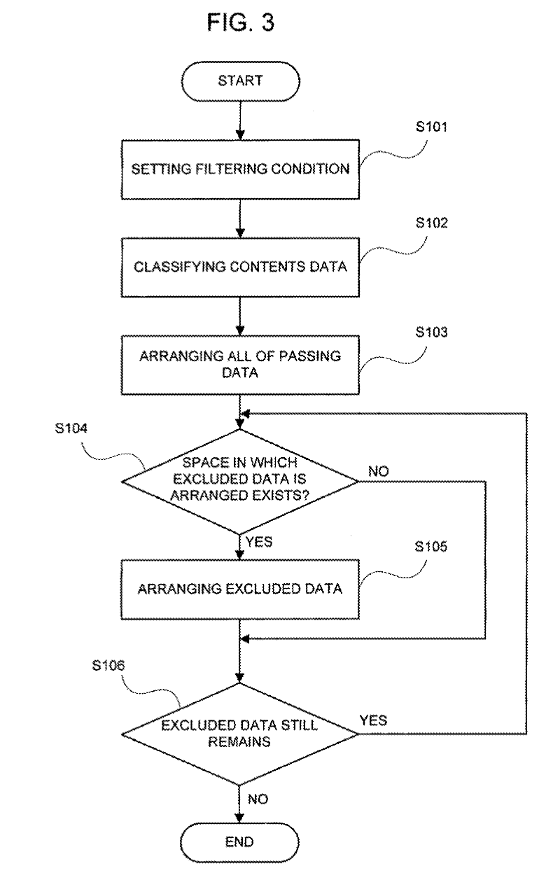

Next, an operation of the first embodiment will be explained by making a reference to the accompanied drawings. FIG. 3 is a flowchart illustrating an operation of the contents display system in the first embodiment.

At first, the filtering condition setting unit 1 outputs the condition under which the contents are filtered to the display data filtering unit 3 (step S101).

It does not matter that the process of the step S101 is performed responding to a user's operation, and it does not matter that the contents display system detects that the display data exists excessively, and automatically sets the filtering condition according to a predetermined criteria.

Next, the display data filtering unit 3 classifies each contents data, which the contents data storage unit 2 stores, into “the passing data” that meets the filtering condition sent by the filtering condition setting unit 1, and “the excluded data” that does not meet the filtering condition (step S102).

Next, in an arrangement position over the coordinate space of the passing data subjected to the classification by the display data filtering unit 3, which is governed by the feature, the passing data thumbnail arrangement unit 4 arranges the thumbnail images of the above passing data (step S103).

Additionally, the thumbnail image of the passing data may be pre-saved by the contents storage unit 2 in such a manner that it is paired with the contents data thereof, and the passing data thumbnail arrangement unit 4 may dynamically generate the thumbnail image of the passing data on the basis of the text of the contents data. Hereinafter, the passing data thumbnail and the excluded data thumbnail are denoted only as the passing data and the excluded data in some cases.

The passing data thumbnail arrangement unit 4 may arrange the thumbnails, for example, in a descending order of the predetermined priority degree affixed to the contents data, to begin with the thumbnail having a high priority degree, as an order in which the thumbnails are arranged, and may arrange the thumbnails in an order in which the contents have been registered. For example, the display data filtering unit 3 has a storage unit (not shown in the figure) store “the passing data” and “the excluded data” subjected to the classification in a descending order of a degree to which the filtering condition is met, to begin with the data having a high degree. And, in the step S103, the passing data thumbnail arrangement unit 4 extracts “the passing data” from the storage unit in a descending order of a degree to which the filtering condition is met, to begin with the passing data having a high degree, and arranges it.

After the passing data thumbnail arrangement unit 4 finishes an arrangement of all of the passing data, continuously, the excluded data thumbnail arrangement unit 5 decides an arrangement position of each excluded data, which has been determined to be excluded data that does not meet the filtering condition by the display data filtering unit 3, over the coordinate space according to the feature. And, the excluded data thumbnail arrangement unit 5 investigates whether the space in which the thumbnail image of the above excluded data is to be displayed is empty (step S104). For example, the excluded data thumbnail arrangement unit 5 extracts “the excluded data” from the storage unit in a descending order of a degree to which the filtering condition is met, to begin with the excluded data having a high degree, and performs the step S104.

When the display position (display range) of the excluded data has already been occupied by the already-arranged thumbnail image (No), the excluded data is not arranged and the operation proceeds to a step S106 because there is no space, in which the excluded data is arranged, in the arrangement position decided in the step S104.

To the contrary, when there is the space in which the excluded data is arranged (Yes), the excluded data thumbnail arrangement unit 5 arranges the excluded data (step S105).

In the step S106, the excluded data thumbnail arrangement unit 5 determines whether or not the excluded data not subjected to the processes of the steps S104 and S105 exists. When it has been determined that the excluded data exists (Yes), the excluded data thumbnail arrangement unit 5 proceeds to the step S104, and repeatedly performs operation of the step S104 and the step S105 for all of the excluded data. When it has been determined that no excluded data exists (No), the excluded data thumbnail arrangement unit 5 finishes a series of the processes.

As a criterion for determining whether the space in the step S104 exists, for example, the following criteria are thinkable. For example, the excluded data thumbnail arrangement unit 5 may determine that the space exists in view of the case that a location in which the excluded data is to be arranged is not occupied by the already-arranged data at all. In this case, the excluded data is arranged only when all of the excluded data (specifically, all of the excluded data thumbnails) is visually recognizable. Further, the excluded data thumbnail arrangement unit 5 may determine that the space exists when the space in which even one part of the excluded data can be displayed exists to arrange one part of the excluded data in such a manner of looking in at the space. In this case, the excluded data needs to be arranged so that it is not piled upon the passing data by arranging it deepest in a depth in order not to obscure the already-arranged passing data. Further, it does not matter that pieces of the excluded data are allowed to overlap each other at the moment of arranging the excluded data because an important matter is that the passing data is not obscured by the excluded data.

In any case, size, color, or shape of the thumbnail of the excluded data is more preferably changed so as to indicate that the thumbnail of the excluded data ought to be originally made a no-display thumbnail of, which is carried out with filtering operation.

Further, a probability that the excluded data thumbnail of which the arrangement order ranks highly is arranged is high because the excluded data thumbnail is arranged so long as it does not disturb the already-arranged thumbnail at the moment of arranging the excluded data thumbnail. Thereupon, as an order in which the excluded data thumbnail are arranged, it is more preferably to earlier arrange the excluded data having a nearer distance to the filtering condition set by the filtering condition setting unit 1 without arranging the excluded data according to the priority degree etc. affixed originally to the contents, or the registration order like the case of the passing data thumbnail arrangement unit 4.

The so-called excluded data having a nearer distance to the filtering condition is data that meets the condition in the first place when the filtering condition is relaxed little by little, and becomes passing data. Doing so allows the thumbnail of the data, which is near to the filtering condition and is valuable, out of the excluded data, to be preferredly arranged. That is, the excluded data is arranged in a descending order of being near to the filtering condition, to begin with the excluded data of which the condition is nearest to the filtering condition. This enables the user to simply grasp which excluded data is transited to the passing data by re-setting the filtering condition in a more relaxed level from now on.

Next, an advantageous effect of the first embodiment will be explained. The first embodiment is configured so that when the filtering condition is set, not only the passing data that has met the condition is displayed, but also the excluded data is displayed so long as it does not disturb the display of the passing data. With this, it is possible to intelligibly grasp a distribution or a density of the data over the coordinate space while paying attention only to the data that has met the filtering condition. The reason is that a possibility that the amount of the contents being displayed is remarkably decreased due to the filtering is eliminated because the contents as well that have not met the filtering condition are arranged if the situation is permitted so long as it does not disturb the data that meets the filtering condition.

Further, the first embodiment has an effect that the user can easily adjust the filtering condition at the moment of filtering the contents being displayed. The reason is that the user can easily grasp which contents are added to a filtering result when relaxing the filtering condition because the contents having a low degree to which the filtering condition is not met, out of the contents that do not meet the filtering condition, are preferredly arranged. That is, the user can simply grasp which excluded data is transited to the passing data by re-setting the filtering condition in a more relaxed level from now on because the excluded data thumbnail arrangement unit 5 displays the data having a nearer distance to the filtering condition more preferredly, out of the excluded data that has not met the filtering condition.

### Second Embodiment

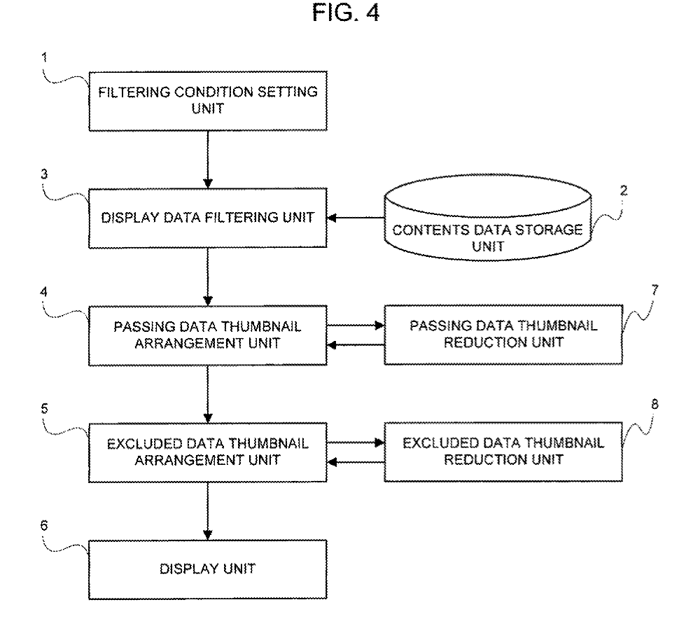

Next, the second embodiment of the present invention will be explained by making a reference to the accompanied drawings. FIG. 4 is a block diagram illustrating the second embodiment of the contents display system in accordance with the present invention. Upon making a reference to FIG. 4, the second embodiment of the present invention differs from the first embodiment (see FIG. 2) in including a passing data thumbnail reduction unit 7 and an excluded data thumbnail reduction unit 8 besides the components shown in FIG. 2. Further, the second embodiment differs from the first embodiment in operations as well of the passing data thumbnail arrangement unit 4 and the excluded data thumbnail arrangement unit 5.

The passing data thumbnail arrangement unit 4 receives the passing data inputted from the display data filtering unit 3, decides the position in which the thumbnail image corresponding to each passing data is arranged on the basis of the feature affixed to the passing data, and arranges the thumbnail image at the above position.

Further, when the thumbnail image of which the arrangement position has been decided overlaps the already-arranged thumbnail, the passing data thumbnail arrangement unit 4 reduces the thumbnail of which the arrangement position has been decided by employing the passing data thumbnail reduction unit 7, shifts the arrangement position so that the thumbnail image does not overlap the already-arranged thumbnail, and arranges the thumbnail image. The passing data thumbnail arrangement unit 4 shifts the reduced thumbnail image, for example, by a predetermined distance, and arranges it.

The passing data thumbnail reduction unit 7 reduces the thumbnail image outputted by the passing data thumbnail arrangement unit 4, and returns it to the passing data thumbnail arrangement unit 4. The passing data thumbnail reduction unit 7 reduces the thumbnail image, for example, by a predetermined multiplying factor.

The excluded data thumbnail arrangement unit 5 decides the position in which the thumbnail image corresponding to each excluded data is arranged on the basis of the feature affixed to the excluded data. The excluded data thumbnail arrangement unit 5 shifts the arrangement position of the thumbnail image reduced by a certain reduction by employing the excluded data thumbnail reduction unit 8, and arranges the thumbnail image. The excluded data thumbnail arrangement unit 5 shifts the reduced thumbnail image, for example, by a predetermined distance, and arranges the reduced thumbnail image.

The excluded data thumbnail reduction unit 8 reduces the thumbnail image outputted by the excluded data thumbnail arrangement unit 5, and returns it to the excluded data thumbnail arrangement unit 5. The excluded data thumbnail reduction unit 8 reduces the thumbnail image, for example, by a predetermined multiplying factor.

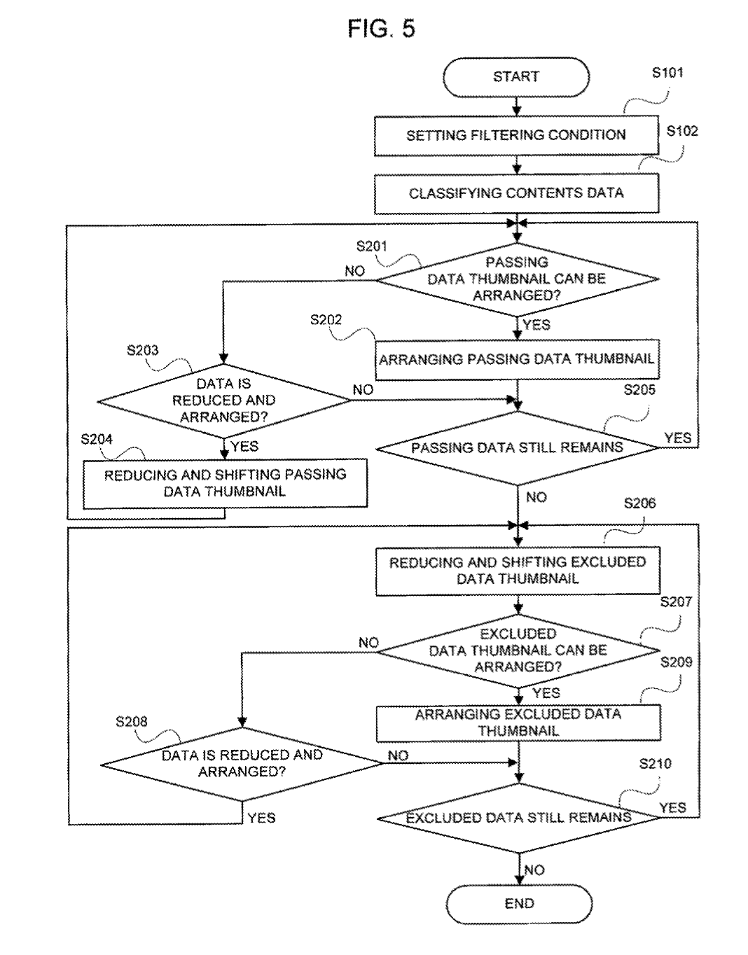

Next, an operation of the second embodiment will be explained by making a reference to the accompanied drawings. FIG. 5 is a flowchart illustrating an operation of the contents display system in the second embodiment. Additionally, processes of a step S101 and a step S102 are identical to those of the flowchart illustrating the operation of the first embodiment (see FIG. 3), so its explanation is omitted.

In the arrangement position over the coordinate space that is governed by the feature of the passing data subjected to the classification by the display data filtering unit 3, the passing data thumbnail arrangement unit 4 in the second embodiment arranges the thumbnail image of the above passing data similarly to the case of the first embodiment.

Additionally, the thumbnail images of the passing data may be pre-saved by the contents storage unit 2 in such a manner that they are paired with the respective pieces of the contents data, and the passing data thumbnail arrangement unit 4 may dynamically generate the thumbnail image of the passing data on the basis of the text of the contents data.

The passing data thumbnail arrangement unit 4 more preferably arranges the thumbnails, for example, in a descending order of the predetermined priority degree affixed to the contents data, to begin with the thumbnail having a high priority degree as an order in which the thumbnails are arranged. For example, the display data filtering unit 3 has a storage unit (not shown in the figure) store “the passing data” and “the excluded data” subjected to the classification in a descending order of a degree to which the filtering condition is met, to begin with the data having a high degree. And, the passing data thumbnail arrangement unit 4 extracts “the passing data” from the storage unit in a descending order of a degree to which the filtering condition is met, to begin with the passing data having a high degree, and performs the following process.

In the second embodiment, the passing data thumbnail arrangement unit 4 determines whether or not the passing data thumbnail can be arranged in the course of sequentially arranging the passing data thumbnails (step S201). When it has been determined that the passing data thumbnail can be arranged (Yes), the passing data thumbnail arrangement unit 4 arranges the passing data thumbnail (step S202).

On the other hand, when the passing data thumbnail is superposed upon the already-arranged thumbnail (No), the passing data thumbnail arrangement unit 4 does not arrange the passing data thumbnail in the above location, but determines whether or not it is reduced and arranged (step S203).

When it has been determined in the step S203 that the passing data thumbnail is reduced and arranged (Yes), the passing data thumbnail reduction unit 7 reduces the passing data thumbnail by a predetermined multiplying factor. In addition, the passing data thumbnail arrangement unit 4 calculates the position shifted by a predetermined distance from the original arrangement position (step S204), and proceeds to the step S201. In the step S201, the passing data thumbnail arrangement unit 4 tries to arrange the passing data thumbnail of which the size and the position has been reduced and shifted, respectively. Reducing the thumbnail size and shifting the position enhances a possibility that the passing data thumbnail can be arranged.

When the passing data thumbnail was not able to be arranged notwithstanding it, the passing data thumbnail arrangement unit 4 tries the reduction of the size and the shift of the position repeatedly until the arrangement of the passing data thumbnails is enabled. However, the arrangement of the data that was not able to be arranged even though the reduction of the size was repeated by the specified number of times may be abandoned. For example, in the step S203, the passing data thumbnail arrangement unit 4 regards the case that the predetermined condition (for example, the case that the repetitious number of times is a specified number of times or less) is met as a case that the data is arrangable by the reduction (Yes), and repeatedly performs the processes of the step S204 and the step S201. The passing data thumbnail arrangement unit 4 regards the case that the predetermined condition (for example, the case that the repetitious number of times exceeds a specified number of times) is not met as a case that the data is not arrangable by the reduction (No), and proceeds to a step S205.

In the step S205, the passing data thumbnail arrangement unit 4 determines whether or not the passing data not subjected to the process of the step S201 to the step S204 exists. When it has been determined that the passing data exists (Yes), the passing data thumbnail arrangement unit 4 proceeds to the step S201, and performs the operation of the step S201 to the step S204 for all of the passing data repeatedly. When it has been determined that no passing data exists (No), the passing data thumbnail arrangement unit 4 proceeds to a step S206.

After the passing data thumbnail arrangement unit 4 finishes an arrangement of all of the passing data, continuously, the excluded data thumbnail arrangement unit 5 tries to arrange each excluded data determined to be data that does not meet the filtering condition by the display data filtering unit 3.

At first, the excluded data thumbnail reduction unit 8 reduces the excluded data thumbnail by a predetermined multiplying factor. In addition, the excluded data thumbnail arrangement unit 5 calculates the position shifted by a predetermined distance from the arrangement position over the coordinate space that is governed by the above feature (step S206), and proceeds to a step S207. In the step S207, the excluded data thumbnail arrangement unit 5 tries to arrange the excluded data thumbnail of which the size and the position has been reduced and shifted, respectively. That is, the excluded data thumbnail arrangement unit 5 determines whether or not the excluded data thumbnail can be arranged (step S207). When it has been determined that the excluded data thumbnail can be arranged (Yes), the excluded data thumbnail arrangement unit 5 arranges the excluded data thumbnail (step S209).

The excluded data thumbnail arrangement unit 5 proceeds to the step S206 and the S207 when the excluded data thumbnail is superposed upon the already-arranged thumbnail (No). In the step S207, the excluded data thumbnail arrangement unit 5 further tries the reduction of the size and the shift of the position repeatedly until the arrangement is enabled (Yes) (step S206 and S207). However, the arrangement of the data that was not able to be arranged even though the reduction of the size was repeated by the specified number of times may be abandoned. For example, when it has been determined in the step S207 that the excluded data thumbnail is superposed (No), the excluded data thumbnail arrangement unit 5 may perform the process of the step S208, as shown in FIG. 5. In the step S208, the excluded data thumbnail arrangement unit 5 regards the case that the predetermined condition (for example, the case that the repetitious number of times is a specified number of times or less) is met as a case that the data is arrangable by the reduction (Yes), and repeatedly performs the processes of the step S206 and the step S207. The excluded data thumbnail arrangement unit 5 regards the case that the predetermined condition (for example, the case that the repetitious number of times exceeds a specified number of times) is not met as a case that the data is not arrangable by the reduction (No), and proceeds to a step S210.

In the step S210, the excluded data thumbnail arrangement unit 5 determines whether or not the excluded data not subjected to the process of the step S206 to the step S209 exists. When it has been determined that the excluded data exists (Yes), the excluded data thumbnail arrangement unit 5 proceeds to the step S206, and performs the operation of the step S206 to the step S209 for all of the excluded data repeatedly. When it has been determined that no excluded data exists (No), the excluded data thumbnail arrangement unit 5 finishes a series of the processes.

Next, an advantageous effect of the second embodiment will be explained. In the second embodiment, while the thumbnail is reduced, and yet the position thereof is shifted little by little, the thumbnails are arranged in the adjacent of the position over the coordinate space, which is indicated by the feature of the data of the above thumbnail, so that they do not overlap each other. Making such a configuration yields an effect that the user's visual recognizability is improved because the thumbnails do not overlap each other. Further, the arrangement in which the text and the amount of an aggregation of the thumbnails can be easily grasped can be realized because the thumbnail of the data having a high priority degree is displayed gigantically and visibly and the thumbnail having a low priority degree, which is located closely to the above thumbnail having a high priority degree, is displayed dwarfishly and numerously.

In addition, the excluded data that does not meet the filtering condition is reduced to a predetermined size or less at any time, and is displayed at a position shifted from the original position although the display itself is performed. With this, the excluded data is displayed more inconspicuously and more unconcernedly while it keeps a positional relation with the data that has met the condition, thereby enabling the user to more intelligibly grasp a distribution or a relevancy of the data over the coordinate space.

### Example 1

Next, specific examples of the present invention will be explained. The first example, which corresponds to the first embodiment, is an example of the case that the contents display system in accordance with the present invention is applied for a map retrieval system for displaying a retrieval result of facilities on the map with the icons.

The general-purpose map retrieval system is, for example, a system in which the user inputs positional information of an address etc. as a retrieval condition, thereby allowing the map in the neighborhood of the inputted address to be displayed, and the icons indicative of the position of the restaurants to be displayed on the map.

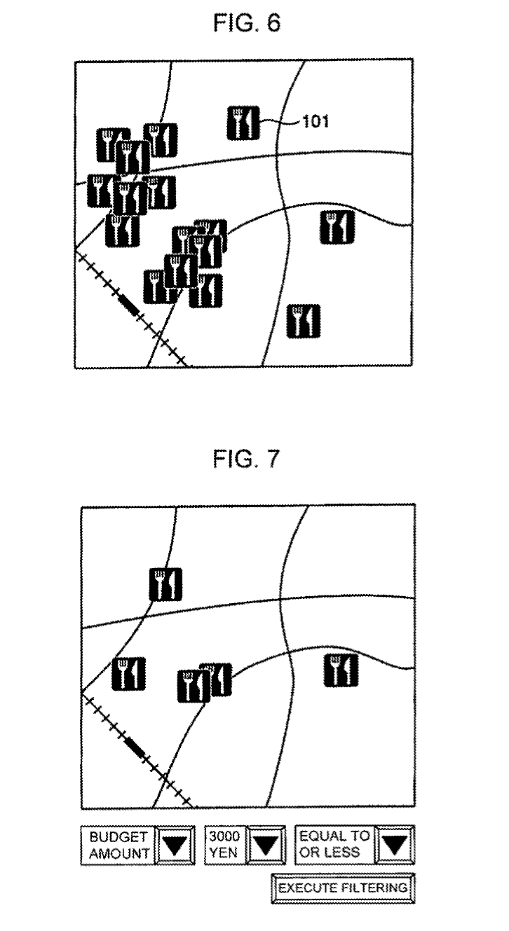

At first, an exemplary output in the general-purpose map retrieval system will be explained. FIG. 6 is an explanatory view illustrating an exemplary output in the case of having retrieved the restaurants by employing the general-purpose map retrieval system. An icon 101 is displayed, for example, on the map in the neighborhood of the inputted address, and is indicative of the position of the restaurant. Additionally, in FIG. 6, a code is affixed to only one icon. When the number of the icons, being an output result, is too many, and the icons are difficult to view, the user can filter the retrieval result by setting some conditions.

FIG. 7 is an explanatory view illustrating an exemplary output in the case of having further filtered the retrieved restaurants under the filtering condition in the general-purpose map retrieval system. FIG. 7 shows an exemplary output in the case of having filtered the restaurants under the condition that an average budget is 3000 yen or less in the map retrieval system. The number of the icons is decreased, and the screen is more visible; however it is entirely unknown where the restaurants of which the average budget slightly exceeds 3000 yen are located unless the filtering condition is changed because the icons indicative of the restaurants of which the average budget exceeds 3000 have been erased without discrimination. Further, information of a distribution that the restaurants are concentrated in front of a station has been lost. The general-purpose map retrieval system has a room for improvement in such a point.

Next, as the first example, an example of the case of applying the contents display system in order to further filter the icons that are displayed on the map in the map retrieval system will be explained. For example, the map retrieval system includes the contents display system shown in FIG. 2 as a function of further filtering the icons that are displayed on the map in the map retrieval system.

The content data storage unit 2 stores restaurant data as the contents data. The restaurant data includes, for example, identification information that makes each restaurant identifiable, the positional information, and information of the average budget amount etc. In the following explanation, the case that the restaurant data in the neighborhood of the address, which has been inputted by the user etc., is pre-extracted in the map retrieval system, and is stored in the contents data storage unit 2 will be exemplified.

The map retrieval system in the first example, at first, arranges only the icons of the restaurants of which the budget is 3000 yen or less on the map similarly to the general-purpose map retrieval system. At that moment, no limit is put to the mutual overlap of the icons of the restaurants of which the budget is 3000 yen or less.

For example, the filtering condition setting unit 1 sets the filtering condition “the average budget amount is 3000 yen or less”, which has been inputted by the user. The display data filtering unit 3 extracts the data of the restaurants that meet “the average budget amount is 3000 yen or less” as “the passing data” from the contents data storage unit 2, and extracts the data of the restaurants that do not meet as “the excluded data”. And, the passing data thumbnail arrangement unit 4 arranges “the passing data” (namely, the icons of the restaurants of which the budget is 3000 yen or less) extracted by the display data filtering unit 3 on the map.

Next, the display data filtering unit 3 has the storage unit store “the excluded data” subjected to the classification in a descending order of a degree to which the filtering condition is met, to begin with the data having a high degree. And, the excluded data thumbnail arrangement unit 5 extracts “the excluded data” from the storage unit in a descending order of a degree to which the filtering condition is met, to begin with the excluded data having a high degree, and tries to arrange the icons thereof.

For example, the excluded data thumbnail arrangement unit 5, at first, re-juxtaposes the restaurants having the budget exceeding 3000 yen excluded under the filtering condition in an ascending order of the budget, to begin with the restaurant of which the budget is most inexpensive, and tries to arrange the icons thereof in an ascending order of the budge, to begin with the restaurant of which the budget is most inexpensive. The excluded data thumbnail arrangement unit 5 does not arrange the icon, which will overlap the already arranged icon, but arranges only the icon of which the arrangement position of the space is empty. The size of the icon is pre-decided. However, a configuration may be made so that the user decides it.

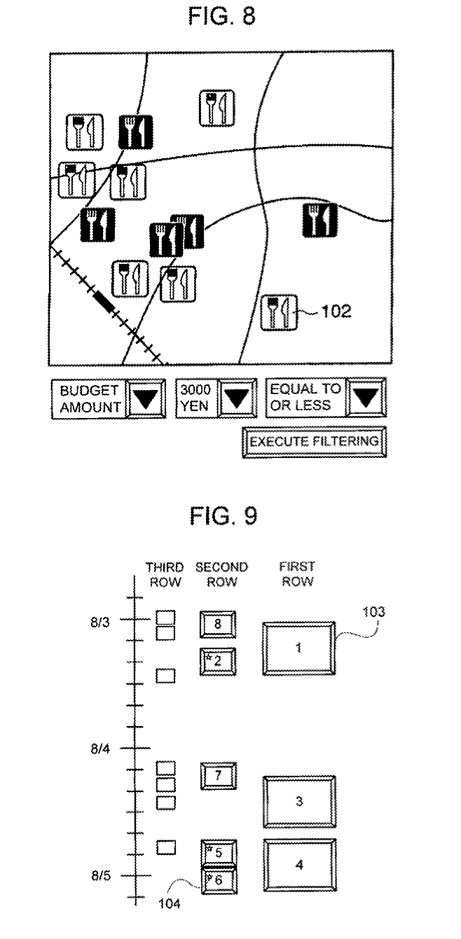

At that moment, the color of the icon of the restaurant that has not met the condition is preferably changed and depicted so as to differentiate the restaurant that has met the condition (the passing data) from the restaurant that has not met the condition (the excluded data). FIG. 8 is an explanatory view illustrating an exemplary output in the case of changing and displaying the color of the icon of the restaurants that have not met the condition. An icon 102 is indicative of the restaurant that has not met the filtering condition. Additionally, in FIG. 8, the code is affixed to only one icon. Differentiating the color of the icon indicative of the restaurant that has met the filtering condition from that of the icon indicative of the restaurant that has not met the filtering condition makes it possible to intelligibly display the positions of the restaurants that have met the filtering condition, and therewith, to unconcernedly display the restaurants other than them so long as they do not disturb, and makes it possible to display information as well that a large number of the restaurants are located in the vicinity of a station.

Further, the first example has an advantageous point that preferredly displaying the restaurants of which the budget is close to 3000 yen, out of the restaurants that have not met the filtering condition, enables the user to simply access the restaurants as well that have been rejected under the condition close to the filtering condition, if the user desires.

### Example 2

Next, the second example of the present invention will be explained. The second example, which corresponds to the second embodiment, is an example of the case that the contents display system in accordance with the present invention is applied for a thumbnail picture viewer for arranging picture image data on a time scale for perusal. For example, the thumbnail picture viewer, which is realized in the contents display system shown in FIG. 2, has a function of further filtering the thumbnail pictures on the time scale being displayed.

FIG. 9 is an explanatory view for illustrating an example of a basic thumbnail arrangement of the thumbnail picture viewer of the second example. In the thumbnail picture viewer, the time line is displayed longitudinally, and all of the thumbnail images are arranged in a just side of the position on the time line indicative of the photographing time of the above picture. The size of the thumbnail is pre-decided. However, a configuration may be made so that the user decides it.

The passing data thumbnail arrangement unit 4, at the moment of arranging the thumbnail images, firstly tries to arrange the thumbnail image in first row, reduces it by half when it overlaps the image already arranged in the first row, and tries to arrange it in a second row. The passing data thumbnail arrangement unit 4 further reduces it by half when it overlaps the image already arranged in the second row, tries to arrange it in a third row, and does not arrange it when it overlaps the image as well already arranged in the third row.

FIG. 9 shows an example of the case of reducing the thumbnail image by a predetermined multiplying factor, shifting the thumbnail image so that it does not overlap, and arranging it. The picture image data is given a priority rank in a descending order of the image quality thereof (the image quality is estimated from shading or contrast). The numerical figure written in a thumbnail image 103 shown in FIG. 9 is representative of a priority rank (the priority rank of the image in the third row is omitted). The thumbnail image 103 is a thumbnail image of which the priority rank is a first rank. The images of which the image quality is excellent are displayed gigantically in the first row, and the images of which the image quality is not so excellent are displayed dwarfishly in the second row/the third row, and so much, a large number of the images results being displayed because the contents display system tries to arrange the images in an order of the priority rank. An aggregation of the thumbnails can be grasped for each event unit because the images resembling each other in the photographing time are arranged as a unified group.

Further, in an example shown in FIG. 9, a star mark 104 indicative of “being favorite” is affixed to some pictures by the user. The contents display system can filter and display only the images with the star mark. When an instruction for the filtering display is given by the user, the system firstly tries to arrange the thumbnail images of only the pictures with the star mark. Hereinafter, an example of the case that the filtering condition setting unit 1 sets “being favorite” as a filtering condition will be explained.

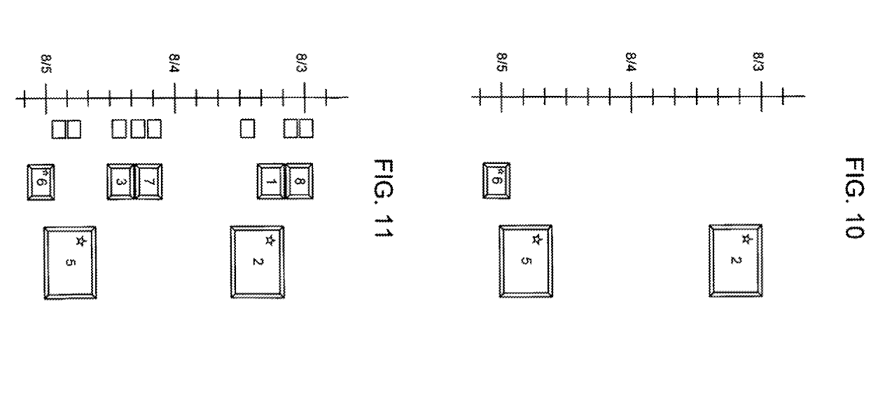

For example, the display data filtering unit 3 has the storage unit store the images with the star mark, being “the passing data”, in a descending order of the image quality, to begin with the image having a high image quality. And, the passing data thumbnail arrangement unit 4 extracts the images with the star mark from the storage unit in a descending order of the image quality, to begin with the image having a high image quality, gigantically arranges the images of which the image quality is excellent in the first row in a preferred manner, and dwarfishly arranges the images of which the image quality is not so excellent in the second row, as described above. FIG. 10 is an explanatory view for illustrating an exemplary output in the case of arranging only the passing data.

Thereafter, the excluded data thumbnail arrangement unit 5 tries to arrange the images as well having no star mark (excluded data). At that moment, the excluded data thumbnail arrangement unit 5 does not try to arrange respective thumbnail images in the first row, but firstly tries to arrange the thumbnail images reduced by half in the second row and in the row after it. FIG. 11 is an explanatory view for illustrating an exemplary output in a situation in which the arrangement of the data having no star mark (excluded data) has been completed.

In the second example, the images that do not meet the filtering condition are not arranged in the first row even though the space is empty. This enables the user to concentrate his/her attention onto only the images having the star mark, and to peruse the pictures of the digital camera. However, the advantageous point of the arrangement method of performing a mapping to time, namely the merit that the images of which the photographing times are close to each other are arranged as a group, and the pictures can be collectively grasped for each event unit is kept alive as it stands in the second example because the images as well having no star mark are not eliminated, but are displayed in the low-rank row even though its size is small.

Additionally, the above-mentioned embodiments indicate the contents display system having the characteristic configurations as shown in the following (1) to (5).

(1) The contents display system of the above-mentioned embodiment, which is a contents display system for arranging the contents-corresponding images corresponding to the contents on the screen based upon the predetermined attribution information, is characterized in including, as the contents arrangement means, a first contents arrangement means (which is realized, for example, with the passing data thumbnail arrangement unit 4) for arranging the contents-corresponding images corresponding to the contents that have met the predetermined filtering condition, and a second contents arrangement means (which is realized, for example, with the excluded data thumbnail arrangement unit 5) for arranging the contents-corresponding images corresponding to the contents that have not met the filtering condition at a position in which a visual recognition of at least one part of the above contents-corresponding images is not obstructed by the contents-corresponding images arranged by the first contents arrangement means.

(2) The contents display system of the above-mentioned embodiment is a contents display system in which the second contents arrangement means (which is realized, for example, with the excluded data thumbnail arrangement unit 5 and the excluded data thumbnail reduction unit 8) reduces the contents-corresponding image corresponding to the contents that have not met the filtering condition by the predetermine multiplying factor, shifts it in such a manner that it does not overlap the other contents-corresponding images, and arranges it. In the contents display system configured in such a manner, inconspicuously and unconcernedly displaying the contents that have not met the filtering condition while keeping a positional relation with the contents that have met the filtering condition without disturbing the contents that have met the filtering condition makes it possible to intelligibly grasp a distribution or a relevancy of the data.

(3) The contents display system of the above-mentioned embodiment is a contents display system in which the first contents arrangement means arranges the contents-corresponding images corresponding to the contents that have met the filtering condition on the screen irrespective of whether these contents-corresponding images overlap each other, and the second contents arrangement means arranges the contents-corresponding images corresponding to the contents that have not met the filtering condition on the screen only when a visual recognition of all of the above contents-corresponding images is not obstructed by the contents-corresponding images arranged by the first contents-corresponding images. In the contents display system configured in such a manner, a configuration can be made so that the contents that have met the filtering condition are displayed with these contents piled upon each other, and the contents that have not met the filtering condition are not displayed with these contents piled upon each other.

(4) The contents display system of the above-mentioned embodiment is a contents display system in which the second contents arrangement means arranges the contents-corresponding images corresponding to the contents that have not met the filtering condition in a descending order of being near to the filtering condition, to begin with the contents of which the condition is nearest to the filtering condition. The contents display system configured in such a manner enables the user to easily adjust the filtering condition because the user can easily grasp which contents meet the filtering condition when relaxing the filtering condition.

Above, although the present invention has been particularly described with reference to the preferred embodiments and examples thereof, it should be readily apparent to those of ordinary skill in the art that the present invention is not always limited to the above-mentioned embodiment and examples, and changes and modifications in the form and details may be made without departing from the spirit and scope of the invention.

This application is based upon and claims the benefit of priority from Japanese patent application No. 2007-285207, filed on Nov. 1, 2007, the disclosure of which is incorporated herein in its entirety by reference.

### HOW THE INVENTION IS CAPABLE OF INDUSTRIAL EXPLOITATION

The present invention is effectively applicable so as to peruse data saved in a storage within an information terminal. Further, it is also applicable to an application of perusing data saved in a server through a network.

1-15. (canceled)

16. A contents display system, comprising:
a first contents arrangement unit that arranges contents-corresponding images corresponding to contents that have met a predetermined filtering condition on a screen based upon predetermined attribution information; and
a second contents arrangement unit that reduces the contents-corresponding images corresponding to the contents that have not met said filtering condition by a predetermined multiplying factor, and arranges them at a position in which a visual recognition of all of the above contents-corresponding images is not obstructed by the contents-corresponding images arranged by said first contents arrangement means.

17. A contents display system according to claim 16, wherein the second contents arrangement means arranges the contents-corresponding images corresponding to the contents that have not met the filtering condition in a descending order of being near to the filtering condition, to begin with the contents of which the condition is nearest to the filtering condition.

18. A contents display method, comprising:
a first contents arrangement step of arranging contents-corresponding images corresponding to contents that have met a predetermined filtering condition on a screen based upon predetermined attribution information; and
a second contents arrangement step of reducing the contents-corresponding images corresponding to the contents that have not met said filtering condition by a predetermined multiplying factor, and arranging them at a position in which a visual recognition of all of the above contents-corresponding images is not obstructed by the contents-corresponding images arranged by said first contents arrangement step.

19. A contents display method according to claim 18, wherein the second contents arrangement step arranges the contents-corresponding images corresponding to the contents that have not met the filtering condition in a descending order of being near to the filtering condition, to begin with the contents of which the condition is nearest to the filtering condition.

20. A computer-readable medium storing a contents display program, said contents display program causing an information processing device to execute:
a first contents arrangement process of arranging contents-corresponding images corresponding to contents that have met a predetermined filtering condition on a screen based upon predetermined attribution information; and
a second contents arrangement process of reducing the contents-corresponding images corresponding to the contents that have not met said filtering condition by a predetermined multiplying factor, and arranging them at a position in which a visual recognition of all of the above contents-corresponding images is not obstructed by the contents-corresponding images arranged by said first contents arrangement process.

21. A computer-readable medium storing contents display program according to claim 20, wherein the second contents arrangement process arranges the contents-corresponding images corresponding to the contents that have not met the filtering condition in a descending order of being near to the filtering condition, to begin with the contents of which the condition is nearest to the filtering condition.
